(19) United States
(12) Patent Application Publication
(10) Pub. No.: US 2005/0235304 A1
(43) Pub. Date: Oct. 20, 2005

(54) Automatic balancing apparatus and rotative apparatus using the same

(76) Inventor: Yuji Shishido, Kanagawa (JP)

Correspondence Address: JAY H. MAIOLI;Cooper & Dunham LLP, 1185 Avenue of the Americas, New York, NY, 10036, US

(21) Appl. No.: 11/089,196

(22) Filed: Mar. 24, 2005

(30) Foreign Application Priority Data
Apr. 19, 2004 (JP) P2004-123174

(51) Int. Cl. G11B 17/028; G11B 17/03; G11B 19/20; G01M 1/16

(52) U.S. Cl. 720/701; 73/468

(57) ABSTRACT

An automatic balancing apparatus includes a balancer made of a magnetic fluid, a housing member rotatably provided and for housing the balancer, and a flat magnet disposed integrally rotatable within the housing member and to extend from a center of rotation to an outer circumferential side of the housing member. Accordingly, the automatic balancing apparatus can start rotating with the balancer held by the magnet irrespective of the attitude of the automatic balancing apparatus, whereby the balance of rotation can be improved in a stable manner.

### CROSS REFERENCE TO RELATED APPLICATONS

The present invention contains subject matter related to Japanese Patent Application JP2004-123174, filed to the Japanese Patent Office on Apr. 19, 2004, the entire content of which being incorporated herein by reference.

### BACKGROUND OF THE INVENTION

1. Field of the Invention

The present invention relates to an automatic balancing apparatus for maintaining balance of rotation, and a rotative apparatus equipped with the automatic balancing apparatus.

2. Description of Related Art

In recent years, it has been known that in a disc drive such as an optical disc drive or a magnetic disc drive for recording and reproducing data, rotation of the disc becomes unbalanced during rotation of the disc on a turntable, so that the stability of recording and reproduction decreases.

Technology has been disclosed for improving the balance of rotation of discs, in which a disc-shaped member having a space or chamber in which a magnetic fluid can be housed is disposed so that the disc-shaped member can rotate integrally with the motor shaft. The disc-shaped member has a boss section at its center, and a ring magnet is provided on the side periphery of the boss section. The motor is supported by a subchassis, and the subchassis is supported on a main chassis by means of elastic members. In this construction, when the rotation speed of the motor is low, the magnetic fluid is attracted to the ring magnet so that a disc can be prevented from losing the balance of rotation. As the rotation speed of the motor increases and centrifugal force due to the rotation of the motor becomes larger, the magnetic fluid moves toward, for example, an outer circumferential side so as to ensure the balance of rotation (refer to, for example, Patent Document 1 (Japanese Patent Laid-Open No. HEI4-312244 (Paragraph [0006], FIG. 1)).

### SUMMARY OF THE INVENTION

However, in the art disclosed in Patent Document 1, when a disc drive is positioned in vertical attitude, i.e., the recording surface of a disc is positioned at right angles to the ground, the distance between the ring magnet and the magnetic fluid accumulated in the bottom section of the disc-shaped member is large, so that the magnetic fluid cannot easily be returned to or held by the ring magnet. This leads to the problem that when the disc drive is positioned in certain attitudes, it is difficult to ensure the balance of rotation of the disc. In addition, there is the problem that when the magnetic fluid moves by centrifugal force in a direction approximately opposite to the direction in which the rotation center of the disc deviates, the magnetic fluid flows along the outer circumference of the disc-shaped member and the deviation of the magnetic fluid disappears, so that the balance of rotation is difficult to considerably improve with a small amplitude of vibration.

The present invention has been conceived in view of the above-mentioned problems, and intends to provide an automatic balancing apparatus capable of improving the balance of rotation irrespective of attitudes, as well as a rotative apparatus equipped with such automatic balancing apparatus.

An automatic balancing apparatus according to a preferred embodiment of the present invention includes a balancer made of a magnetic fluid, a housing member rotatably provided and for housing the balancer, and a flat magnet disposed integrally rotatable within the housing member and to extend from a center of rotation to an outer circumferential side of the housing member.

In the automatic balancing apparatus according to a preferred embodiment of the present invention, the magnet is provided to extend from the central side to the outer circumferential side of the housing member. Accordingly, when the automatic balancing apparatus starts rotating in vertical attitude, for example, even if the balancer accumulates in the bottom section of the housing member, magnetic force can be made to act on the balancer from the vicinity thereof, whereby the balancer can be reliably returned to and held by the magnet irrespective of the attitude of the automatic balancing apparatus. Accordingly, the automatic balancing apparatus can start rotating with the balancer held by the magnet irrespective of the attitude of the automatic balancing apparatus, whereby the balance of rotation can be improved in a stable manner. In addition, the magnet has a flat shape. Accordingly, even if the magnet is provided in the inside of the housing member, the amount of the balancer can be ensured by decreasing the thickness of the magnet in the axial direction of rotation of the housing member.

According to a preferred embodiment of the invention, the automatic balancing apparatus further includes a restrictive member provided on the outer circumferential side of the housing member and operative to restrict movement of the balancer in a circumferential direction when the housing member rotates. According to this preferred embodiment of the invention, the balancer is held on the central side of the magnet irrespective of the attitude of the automatic balancing apparatus, and when the automatic balancing apparatus starts rotating, the restrictive member is prevented from hindering the movement of the balancer, whereby the automatic balancing apparatus can be made to rotate stably. In addition, when the automatic balancing apparatus rotates, the flow of the balancer along the inside surfaces of the housing member can be restricted by the restrictive member. Accordingly, even if the amplitude of vibration during the rotation of, for example, a disc is small, the balanced state of rotation of the disc can be ensured by the balancer locally accumulated by the restrictive members according to a preferred embodiment of the present invention. In addition, it is possible to considerably improve the balance of rotation of the automatic balancing apparatus by efficiently using a small amount of balancers.

According to another preferred embodiment of the present invention, the magnet is provided to extend from a central side to the outer circumferential side of the housing member so as to overlap with the restrictive members. According to such construction, the balancer on the outer circumferential side of the housing member can be more reliably held by the magnet, whereby the balance of rotation of the automatic balancing apparatus can be improved by effectively using the balancer.

According to another preferred embodiment of the present invention, the magnet includes a plurality of magnets disposed to be opposed to each other in an axial direction of rotation. According to such construction, the force of the magnet to hold the balancer can be improved by increasing the magnetic flux density in the inside of the housing member. Accordingly, as compared with the case where the holding force is not improved, in the case where the holding force is improved, the balancer can be held on the magnets even during rotation of far higher rotation frequency. In other words, it is possible to lower the lower limit of low-speed rotation frequencies which allow the balancer to be held on the magnets. Accordingly, it is possible to stably rotate the automatic balancing apparatus during low-speed rotation.

According to another preferred embodiment of the present invention, the magnet is provided on an outside section of the housing member. According to such construction, the internal space of the housing member in which the balancer moves can be made larger as compared with the case where the magnet is disposed in the inside of the housing member, whereby it is possible to widen the range of adjustment when the amount of the balancer is to be adjusted during the manufacture of the automatic balancing apparatus.

A rotative apparatus according to a preferred embodiment of the present invention includes a balancer made of a magnetic fluid, a housing member rotatably provided and for housing the balancer, and a flat magnet provided in the housing member to extend from a center of rotation to an outer circumferential side of the housing member, and a drive section which integrally rotates the housing member and the magnet.

In the rotative apparatus according to a preferred embodiment of the present invention, the magnet is provided to extend from the central side to the outer circumferential side of the housing member. Accordingly, the balancer can be reliably returned to and held by the magnet irrespective of the attitude of the automatic balancing apparatus. Accordingly, the automatic balancing apparatus can start rotating with the balancer held by the magnet irrespective of the attitude of the automatic balancing apparatus, whereby the balance of rotation can be improved in a stable manner.

As described above, at the starting time of rotation of the automatic balancing apparatus, the automatic balancing apparatus can be rotated in such a manner that the balancer accumulated on the outer circumferential side of the housing member is returned to and held by magnetic force irrespective of the attitude of the automatic balancing apparatus, whereby the balance of rotation of the automatic balancing apparatus can be improved in a stable manner.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a horizontal cross-sectional view showing an automatic balancing apparatus according to a first embodiment of the present invention (a cross-sectional view of the automatic balancing apparatus, taken along line B-B in FIG. 2);

FIG. 2 is a vertical cross-sectional view of the automatic balancing apparatus shown in FIG. 1 (taken along line A-A in FIG. 1);

FIG. 3 is a vertical cross-sectional view of a disc rotative apparatus according to a first preferred embodiment of the present invention;

FIG. 4 is a vertical cross-sectional view showing the stopped state or the like of the automatic balancing apparatus of the first preferred embodiment;

FIG. 5 is a vertical cross-sectional view showing the rotating state of the automatic balancing apparatus of the first preferred embodiment;

FIG. 6 is a vertical cross-sectional view showing the balanced state of the automatic balancing apparatus of the first preferred embodiment;

FIG. 7 is a vertical cross-sectional view showing the returned state of a balancer in the automatic balancing apparatus of the first preferred embodiment;

FIG. 8 is a horizontal cross-sectional view showing an automatic balancing apparatus according to a second preferred embodiment of the present invention (a cross-sectional view of the automatic balancing apparatus, taken along line D-D in FIG. 9);

FIG. 9 is a vertical cross-sectional view showing an automatic balancing apparatus shown in FIG. 8 (taken along line C-C in FIG. 8);

FIG. 10 is a vertical cross-sectional view showing an automatic balancing apparatus according to a third preferred embodiment of the present invention;

FIG. 11 is a vertical cross-sectional view showing an automatic balancing apparatus according to a fourth preferred embodiment of the present invention;

FIG. 12 is a vertical cross-sectional view showing an automatic balancing apparatus according to a fifth preferred embodiment of the present invention; and

FIG. 13 is a vertical cross-sectional view showing an automatic balancing apparatus according to a sixth preferred embodiment of the present invention.

### DESCRIPTION OF THE PREFERRED EMBODIMENTS

Preferred embodiments of the present invention will be described below with reference to the accompanying drawings.

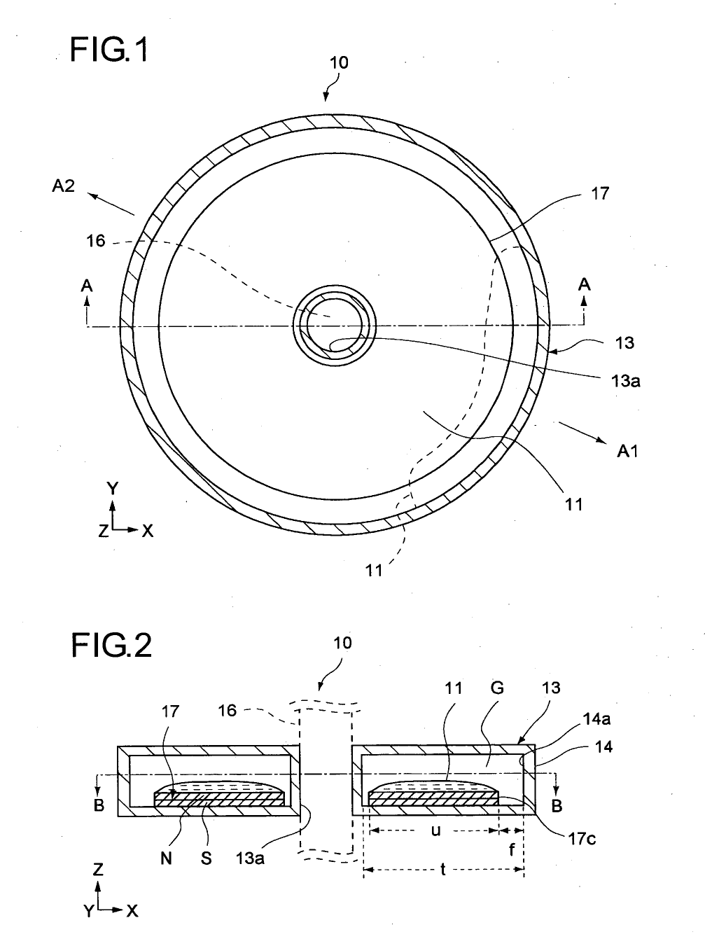

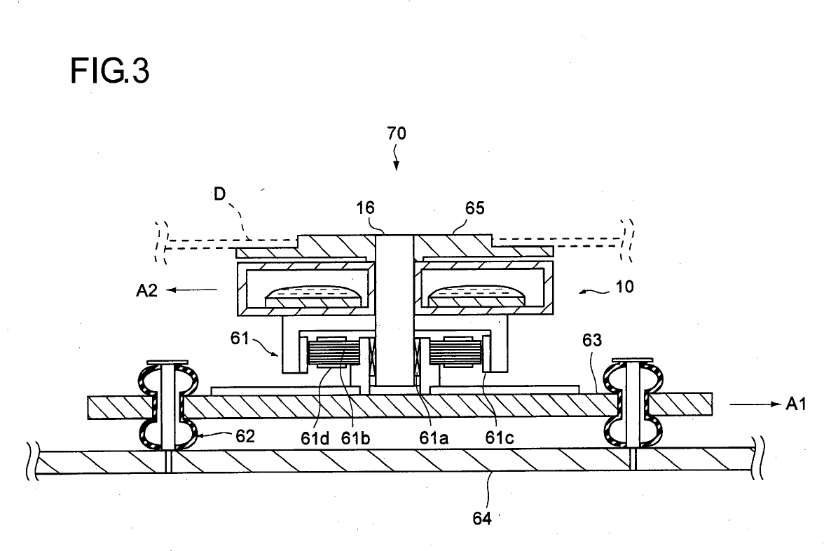

FIGS. 1 and 2 represent, respectively, horizontal and vertical cross-sectional views showing an automatic balancing apparatus according to a first preferred embodiment of the present invention. FIG. 3 is a vertical cross-sectional view showing a disc rotation apparatus according to a preferred embodiment of the present invention.

An automatic balancing apparatus 10 according to the first preferred embodiment includes a balancer 11 made of a magnetic fluid, a flat disk-shaped magnet 17 having a hole at its center, and a disk-shaped housing member 13 having an internal space G in which the balancer 11 and the magnet 17 are housed.

A through-hole 13a through which a rotation shaft 16 of a motor 61 shown in FIG. 3 is provided in the housing member 13 is provided at the center of the housing member 13. The constituent material of the housing member 13 uses metal or synthetic resin, for example.

The magnet 17 is provided to extend from the central side to an outer circumferential side of the housing member 13. The thickness of the magnet 17 in the Z direction that corresponds to the axial direction of rotation of the housing member 13 is set to be no larger than ½ of the length of the internal space G in the Z direction, for example. In FIG. 2, symbol t denotes a width of the internal space G in the direction from a central side to an outer circumferential side of the housing member 13 (the x direction) and symbol u denotes a width of the magnet 17 in the x direction, and the width u is set to 50% to 80% ofthe width t. The magnet 17 is provided so that a distance f between an outer circumferential surface 17c of the magnet 17 and a wall surface 14a of the outer circumferential side of a side wall 14 becomes equal to 10% to 40% of the width t, for example. The magnet 17 is magnetized to have, for example, an N pole and an S pole on its top and bottom sides, respectively. The internal space G is preferably filled with an inert gas capable of preventing oxidization and the like of the balancer 11, such as nitrogen gas.

A magnetic fluid, for example, a ferro-fluid (reserved for IBM Corporation) or a magneto-rheological fluid (MR fluid) is used as the balancer 11.

As shown in FIG. 3, a disc rotative apparatus 70 has the motor 61, and a turntable 65 is provided at the top end section of the rotation shaft 16 of the motor 61. The motor 61 has a stator 61b provided with a coil 61d in which, for example, a drive current flows, a rotor 61c rotatably supported by a bearing 61a, and the rotation shaft 16. The automatic balancing apparatus 10 is provided on the rotation shaft 16. The automatic balancing apparatus 10 is constructed so as to integrally rotate with the rotation shaft 16. The motor 61 is supported by a subchassis 63, and the subchassis 63 is supported on a main chassis 64 by means of elastic sections 62 each including a polymer material such as rubber, a metal-made member and the like, whereby a vibration system is constructed. For example, the resonance frequency of the vibration system based on the deformation of the elastic sections 62 is set to be lower than the rotation frequency of a disc D.

The operation of the automatic balancing apparatus 10 will be described below with reference to the drawings.

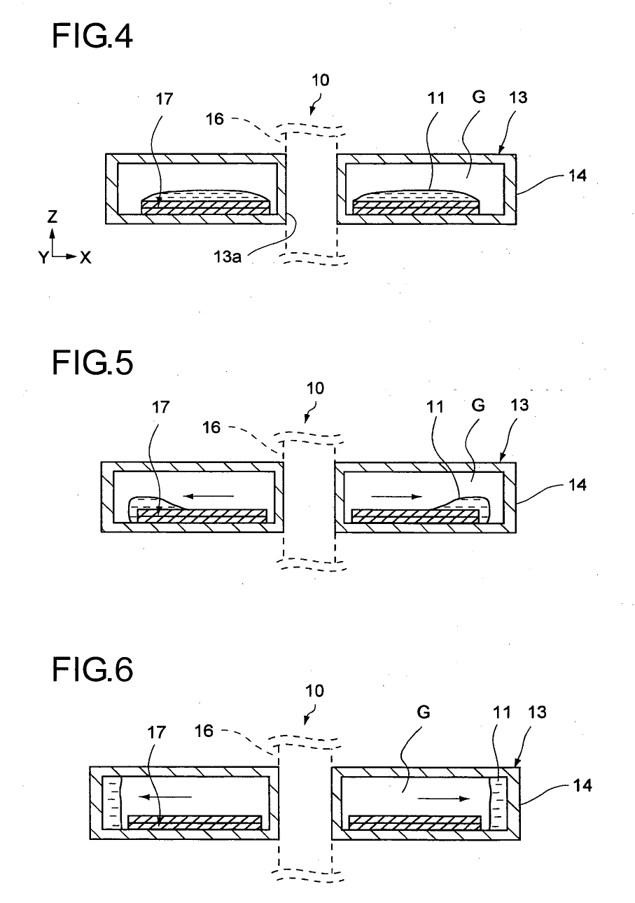

When the disc D is set on the turntable 65 and the motor 61 starts rotation, the vibration system starts to vibrate. As shown in FIG. 4, while the motor 61 rotates at low speed, the centrifugal force is lower than the force of the magnet 17 to hold the balancer 11, and the balancer 11 is held by the magnet 17.

When the rotation speed of the motor 61 increases and the rotation frequency of the motor 61 exceeds the resonance frequency of the vibration system, a direction A1 in which the vibration system vibrates (refer to FIG. 1) becomes approximately opposite to a direction A2 in which the disc D deviates from the rotation center of the motor 61. At this time, the balancer 11 moves in the direction A1 in which the vibration system vibrates, with acceleration due to the vibration of the vibration system, and the direction (A1) in which the balancer 11 moves and the direction A2 in which the disc D deviates become approximately opposite to each other, whereby the balance of rotation of the disc D is ensured.

When the rotation speed of the motor 61 further increases, the force of the magnet 17 to hold the balancer 11 exceeds the centrifugal force, and as shown by a dashed line in FIG. 1 and as shown in FIG. 5, the balancer 11 is moved toward the outer circumferential side of the magnet 17 by the centrifugal force.

When the rotation speed of the motor 61 further increases, the balancer 11 is moved to the outer circumferential side of the magnet 17 by the centrifugal force and is restricted by the side wall 14 of the housing member 13, as shown in FIG. 6.

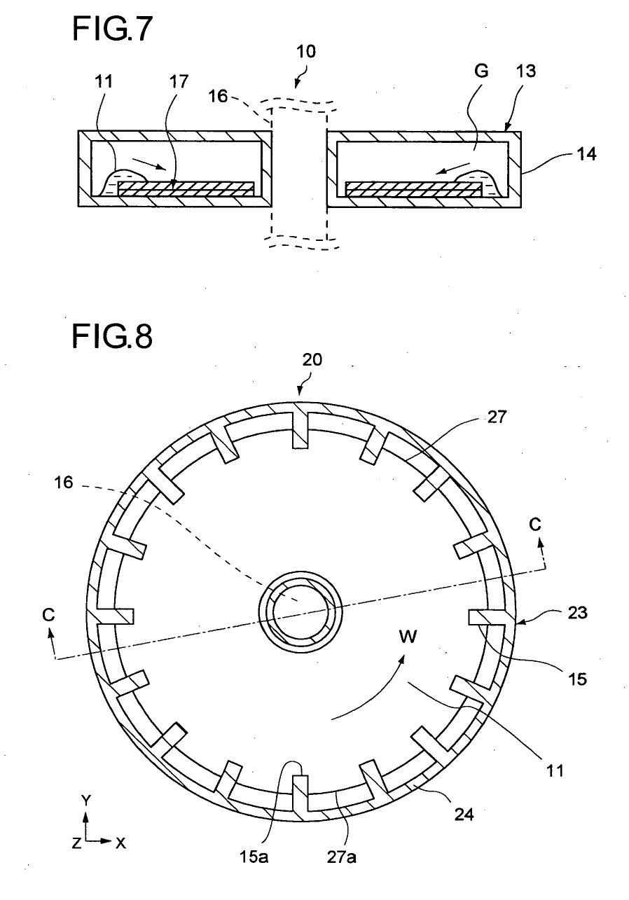

As the rotation speed of the motor 61 decreases, the centrifugal force decreases, and when the centrifugal force decreases below the force of the magnet 17 to hold the balancer 11, the balancer 11 is again moved toward the inner circumferential side of the magnet 17 as shown in FIG. 7.

It is preferable to set the rotation speed of the motor 61 (for example, the rotation speed at which signals recorded on the disc D are reproduced) and the material and the like of the elastic sections 62 so that the direction A1 and the direction A2 can be opposed to each other at approximately 180 degrees.

In the automatic balancing apparatus 10 of the first preferred embodiment, the magnet 17 is provided to extend from the central side to the outer circumferential side of the housing member 13. Accordingly, for example when the motor 61 starts rotating with the automatic balancing apparatus 10 positioned in vertical attitude, even if the balancer 11 accumulates on the bottom side of the housing member 13, magnetic force can be made to act on the balancer 11 from the vicinity thereof, whereby the balancer 11 can be reliably returned to and held by the magnet 17 irrespective of the attitude of the automatic balancing apparatus 10. Accordingly, the automatic balancing apparatus 10 can start rotating with the balancer 11 held by the magnet 17 irrespective of the attitude of the automatic balancing apparatus 10, whereby the balance of rotation of the automatic balancing apparatus 10 can be improved in a stable manner. In addition, the magnet 17 has a flat shape, and the thickness of the magnet 17 in the Z direction is set to not greater than the length of the internal space G in the Z direction, whereby the amount of the balancer 11 can be ensured. Accordingly, even if the magnet 17 is provided in the inside of the housing member 13, the amount of the balancer 11 can be ensured.

In the first preferred embodiment, a kind of fluid is used as the balancer 11. Accordingly, since the impact of the balancer 11 can be reduced during the operation of the disc rotative apparatus 70, the disc rotative apparatus 70 can be constructed to operate with reduced noise and little vibration.

FIGS. 8 and 9 are, respectively, horizontal and vertical cross-sectional views showing an automatic balancing apparatus according to a second preferred embodiment of the present invention.

An automatic balancing apparatus 20 according to the second preferred embodiment includes, instead of the housing member 13, a housing member 23 having a plurality of restrictive members 15 which restrict the flow of the balancer 11 in a circumferential direction W. The restrictive members 15 are disposed to project from a side wall 24 of the housing member 23 toward the center of the housing member 23 approximately perpendicularly to the side wall 24. Each of the restrictive members 15 is spaced apart from its adjacent one at an approximately regular interval in the circumferential direction W. Each of the restrictive members 15 is provided to extend in the Z direction across the entire thickness of the internal space G of the housing member 23. A magnet 27 is provided to extend from the central side to the outer circumferential side of the housing member 23 so as to overlap with the restrictive members 15. In other words, an outer circumferential surface 27c of the magnet 27 is provided on a more outside position than end surfaces 15a of the restrictive members 15. In addition, the number, the shape, the material and the like of the restrictive members 15 are not limitative. For example, the restrictive members 15 may be constructed by preparing planar members which serve as the restrictive members 15, separately from the housing member 13 of the first preferred embodiment, and welding the planar members to the side wall 14 of the housing member 13. Otherwise, the restrictive members 15 may also be formed by integral molding with a resin material.

In the second preferred embodiment, the movement of the balancer 11 toward the outer circumferential side due to the rotation of the automatic balancing apparatus 20 is temporarily restricted by the side wall 24 of the housing member 23, and the flow of the balancer 11 in the circumferential direction W along the side wall 24 is restricted by the restrictive members 15. Accordingly, even if the amplitude of vibration during the rotation of the disc D is small, for example, the balanced state of rotation of the disc D can be ensured by the balancer 11 locally accumulated by the restrictive members 15. When the automatic balancing apparatus 20 is used in a vertical state or the like, the balancer 11 tends to easily deviate vertically downwardly by centrifugal force or gravitational force. However, since the balancer 11 is held on the inner circumferential side by the magnet 17 at the starting time of rotation of the motor 61, the disposition of the restrictive members 15 does not cause any problem. In other words, in the case where the restrictive members 15 are provided, if the balancer 11 remains accumulated in a bottom section of the housing member 23 by gravitational force, the balancing performance of the automatic balancing apparatus 20 will decrease at a subsequent starting time of rotation of the motor 61.

In the second preferred embodiment, the magnet 27 is provided to extend from the central side to the outer circumferential side of the housing member 23 so as to overlap with the restrictive members 15. Accordingly, the balancer 11, even if it is present on the outer circumferential side of the housing member 23, can be reliably held by the magnet 27, whereby the balancer 11 can be effectively used.

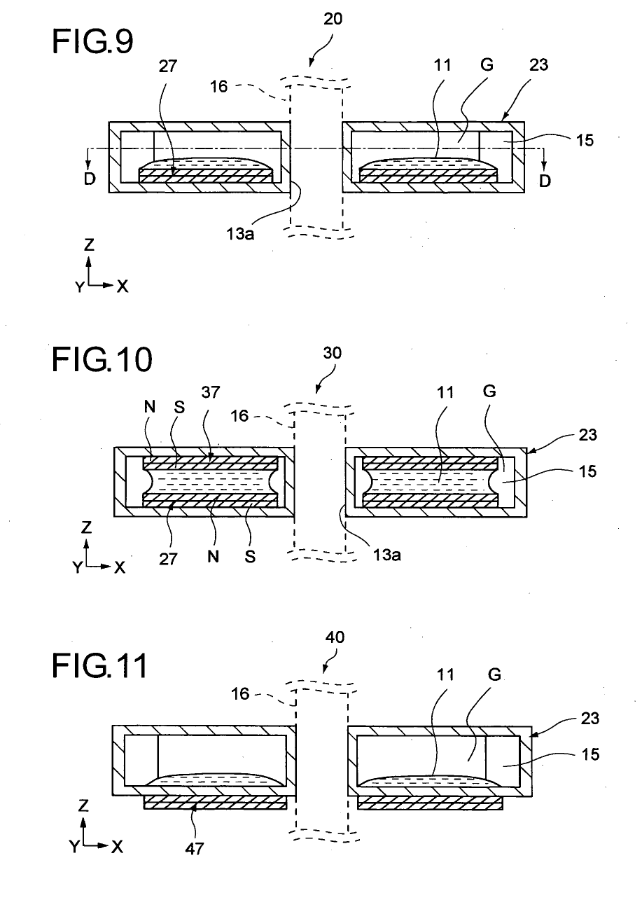

FIG. 10 is a vertical cross-sectional view showing an automatic balancing apparatus according to a third preferred embodiment of the present invention.

In the third preferred embodiment, an automatic balancing apparatus 30 has, in addition to the magnet 27 of the second preferred embodiment, a flat magnet 37 provided to oppose the magnet 27 in the Z direction. Each of the magnets 27 and 37 is magnetized to have an N pole and an S pole on its top and bottom sides, respectively. According to such construction, the force of the magnets 27 and 37 to hold the balancer 11 can be improved by increasing the magnetic flux density in the internal space G of the housing member 23. Accordingly, it is possible to increase the rotation frequency with which the balancer 11 moves toward the outer circumferential side by centrifugal force due to the rotation of the housing member 23, whereby the automatic balancing apparatus 30 can be made to rotate stably during low-speed rotation. In addition, the magnets 27 and 37 may also be provided so that the magnetization direction of each of the magnets 27 and 37 becomes opposite to that in the third preferred embodiment.

FIG. 11 is a vertical cross-sectional view showing an automatic balancing apparatus according to a fourth preferred embodiment of the present invention.

In the fourth preferred embodiment, a magnet 47 is provided on the outside of the housing member 23, for example, in contact with the outside surface of the housing member 23. Accordingly, the internal space G of the housing member 23 in which the balancer 11 moves can be made large compared to the case of any of the above-mentioned preferred embodiments, whereby the amount of the balancer 11 can be increased to effectively improve the balance of rotation of the automatic balancing apparatus.

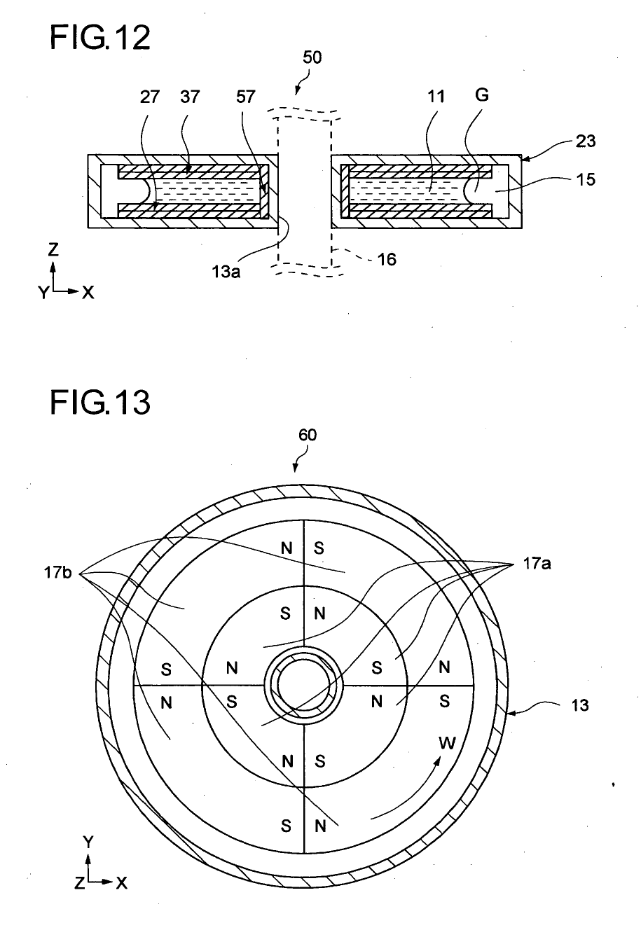

FIG. 12 is a vertical cross-sectional view showing an automatic balancing apparatus according to a fifth preferred embodiment of the present invention.

The fifth preferred embodiment further includes a magnet 57 provided in a cylindrical shape on the inner circumferential side of the housing member 23. The magnet 57 is magnetized, for example, in the vertical direction so as to have an N pole and an S pole on its top and bottom sides, respectively. Accordingly, the capability to hold the balancer 11 on the inner circumferential side of the housing member 23 can be improved, whereby the balance of rotation of the automatic balancing apparatus during a far earlier period can be improved.

FIG. 13 is a vertical cross-sectional view showing an automatic balancing apparatus according to a sixth preferred embodiment of the present invention.

An automatic balancing apparatus 60 according to the sixth preferred embodiment includes a plurality of magnets 17a arranged along the circumferential direction W, and a plurality of magnets 17b arranged along the circumferential direction W on the outer circumferential side of the magnets 17a. Permanent magnets stronger in magnetic force than the magnets 17b are used as the magnets 17a, respectively. The magnetization direction of each of the magnets 17a and 17b is set to be similar to the circumferential direction W. Incidentally, the magnetization direction may also be set to be similar to the Z direction. According to the sixth preferred embodiment, the capability to hold the balancer 11 on the inner circumferential side of the housing member 23 can be improved, whereby the balancer 11 can be more reliably held on the inner circumferential side of the housing member 13 to improve the balance of rotation of the automatic balancing apparatus 60.

While preferred embodiments of the present invention have been described with reference to the attached drawings, it is to be understood that the present invention is not limited to the embodiments described above. It will be obvious to those skilled in the art that various changes, modifications, combinations, subcombinations and alterations may be made depending on design requirements and other factors insofar as they are within the scope of the appended claims or equivalents thereof.

For example, while in each of the second to fifth preferred embodiments, reference has been made to an example in which each of the magnets 27, 37 and 47 extends from the central side to the outer circumferential side so as to overlap with the restrictive members 15, if the length of each of the restrictive members 15 is short, for example, the magnets 27, 37 and 47 may be constructed so as not to overlap with the restrictive members 15. In addition, the diameter of the magnet 17 may be made smaller by using a magnet of stronger magnetic force, whereby the size of the automatic balancing apparatus can be reduced. Conversely, the outer circumferential wall of the magnet 27 may be provided in contact with the side wall 24 of the housing member 23 for example. This construction may prevent the balancer 11 from accumulating in a clearance formed between the outer circumferential wall of the magnet 27 and the side wall 24 of the housing member 23.

In the third preferred embodiment, reference has been made to the example in which the magnet 37 is added to increase the magnetic flux density in the internal space G. However, the magnetic flux density may also be increased by using a permanent magnet of strong magnetic force as the magnet 27 for example.

In the above-mentioned second to fifth preferred embodiments except the fourth preferred embodiment, reference has been made to the construction in which, the magnet 17 is provided in the internal space G of the housing member 13 for example. However, it is possible to achieve similar advantages by burying the magnet 17 in the housing member 13 itself.

In each of the second to sixth preferred embodiments, reference has been made to the example in which the restrictive members 15 are provided to project from the side wall 24 of the housing member 23 toward the center of the housing member 23 at approximately right angles to the side wall 24. However, restrictive members may be provided to project not at approximately right angles to but obliquely from the side wall 24 of the housing member 23, for example. Such construction may make it possible to adjust the capability of the restrictive members to hold the balancer 11.

In the sixth preferred embodiment, reference has been made to the example in which four magnets 17a and four magnets 17b having mutually different magnetic forces are arranged in the circumferential direction W on the inner and outer circumferential sides of the housing member 23, respectively. However, this construction is not limitative, and four layers each including eight magnets arranged in the circumferential direction W may be provided from the inner circumferential side to the outer circumferential side, for example. Reference has also been made to the example in which the magnets 17a and 17b have approximately the same width in the direction from the central side to the outer circumferential side of the housing member 13. However, the width of the magnets 17a and 17b is not limitative, and may also be changed as required.

Any of the automatic balancing apparatuses 10 to 60 of the first to sixth preferred embodiments as well as the disc rotative apparatus 70 can be incorporated into optical disc apparatuses, magnetic disc apparatuses, video cameras using optical discs as recording media, and the like. If any of the automatic balancing apparatuses 10 to 60 as well as the disc rotative apparatus 70 is incorporated into a video camera of the type required to be hand-carried or portable, the balance of rotation of a disc in the video camera can be improved to improve the stability of recording and reproduction of data.

1. An automatic balancing apparatus comprising:
a balancer formed of magnetic fluid;
a rotatable housing member for housing the balancer; and
an integrally rotatable flat magnet provided within the rotatable housing member and extending from a center of rotation thereof to an outer circumferential side of the rotatable housing member.

2. The automatic balancing apparatus according to claim 2, further comprising a restrictive member provided on the outer circumferential side of the rotatable housing member and operative to restrict movement of the balancer in a circumferential direction when the rotatable housing member rotates.

3. The automatic balancing apparatus according to claim 2, wherein the magnet extends from a central side to the outer circumferential side of the rotatable housing member so as to overlap with the restrictive member.

4. The automatic balancing apparatus according to claim 1, wherein the magnet includes a plurality of magnets disposed to be opposed to each other in an axial direction of rotation.

5. The automatic balancing apparatus according to claim 1, wherein the magnet is disposed outside the rotatable housing member.

6. A rotative apparatus comprising:
a balancer formed of magnetic fluid;
a rotatable housing member for housing the balancer;
a flat magnet extending from a center of rotation to an outer circumferential side of the rotatable housing member; and
a driving unit for driving the rotatable housing and the magnet to rotate integrally.

7. The rotative apparatus according to claim 6, further comprising a restrictive member provided on the outer circumferential side of the rotatable housing member for restricting movement of the balancer in a circumferential direction when the rotatable housing member rotates.

8. The rotative apparatus according to claim 7, further comprising a turntable for mounting an optical disc for recording/reproducing data.

9. The rotative apparatus according to claim 6, further comprising a turntable for mounting a magnetic disc for recording/reproducing data.
